(19) United States
(12) Patent Application Publication
(10) Pub. No.: US 2009/0142616 A1
(43) Pub. Date: Jun. 4, 2009

(54) Hot-dip zn-al alloy-plated steel material with excellent bending workability and production method thereof

(76) Inventor: Shiro Fujii, Chiba (JP)

Correspondence Address: KENYON & KENYON LLP, ONE BROADWAY, NEW YORK, NY, 10004, US

(21) Appl. No.: 11/991,196

(22) PCT Filed: Sep. 1, 2005
(86) PCT No.: PCT/JP2005/016465

§ 371 Date: Feb. 27, 2008

(51) Int. Cl. C23C 2/12; B32B 15/04

(52) U.S. Cl. 428/653; 427/398.1

(57) ABSTRACT

A hot-dip Zn—Al alloy-plated steel material ensuring high corrosion resistance and excellent bending workability of the plating layer, and a production method thereof are provided, that is, a hot-dip Zn—Al alloy-plated steel material with excellent bending workability, having a plating layer comprising, in terms of mass %, from 25 to 85% of Al, from 0.05 to 5% of one or both of Cr and Mn, and Si in an amount of 0.5 to 10% of the Al content, with the balance being Zn and unavoidable impurities, wherein the average spangle size on the plating surface is 0.5 mm or more; and a production method thereof.

### TECHNICAL FIELD

The present invention relates to a hot-dip plated steel material used for building materials, automobiles and home appliances. More specifically, the present invention relates to a hot-dip Zn—Al alloy-plated steel material having high corrosion-resisting ability required mainly in the field of usage for building materials and ensuring excellent bending workability of the plating layer, and also relates to a production method thereof.

### BACKGROUND ART

It has been heretofore widely known to improve the corrosion resistance of a steel material by applying Zn plating to the steel material surface. Still at present, a steel material applied with Zn plating is being produced and used in a large amount. However, in many uses, there arises a case that sufficiently high corrosion resistance is not obtained only by Zn plating. In order to enhance the corrosion resistance of the plating layer, a hot-dip Zn—Al alloy-plated steel sheet (Galvalume steel sheet) produced by adding Al is used. For example, in the case of hot-dip Zn—Al alloy plating disclosed in Japanese Examined Patent Publication (Kokoku) No. 61-28748, an alloy comprising Al in an amount of 25 to 75 mass % and Si in an amount of 0.5% or more of the Al content with the balance being substantially Zn is plated and thereby good corrosion resistance is obtained.

However, more enhancement of corrosion resistance is recently demanded mainly in the field of usage for building materials and in order to meet this requirement, the present inventors have previously developed and disclosed a Zn—Al—Cr alloy-plated steel material in Japanese Unexamined Patent Publication (Kokai) No. 2002-356759, where an alloy plating layer is applied by adding Cr and furthermore Mg to a Zn—Al plating layer to obtain high corrosion resistance surpassing the conventional hot-dip Zn—Al alloy plated steel sheet (Galvalume steel sheet). However, when this plated steel material as-is or after coating receives bending deformation, a problem giving rise to reduction of corrosion resistance is sometimes caused, such as generation of cracks in the plating layer or impairment of outer appearance of the bend-worked part.

Accordingly, an object of the present invention is to solve the above-described problems in the Zn—Al—Cr alloy-plated steel material and provide a hot-dip Zn—Al alloy-plated steel material ensuring high corrosion resistance and excellent bending workability of the plating layer, and a production method thereof.

### DISCLOSURE OF THE INVENTION

The present inventors have made various investigations on the plating layer structure of a Zn—Al alloy-plated steel material as well as the production conditions and the bending workability of the plating layer, as a result, it has been found that when the technique disclosed below is applied, a Zn—Al alloy-plated steel material excellent in the bending workability of the plating layer and a production method thereof can be obtained. The present invention has been accomplished based on this finding.

(1) A hot-dip Zn—Al alloy-plated steel material with excellent bending workability, having a plating layer comprising, in terms of mass %, from 25 to 85% of Al, from 0.05 to 5% of one or both of Cr and Mn, and Si in an amount of 0.5 to 10% of the Al content, with the balance being Zn and unavoidable impurities, wherein the average spangle size on the plating surface is 0.5 mm or more.

(2) The hot-dip Zn—Al alloy-plated steel material with excellent bending workability as described in (1), wherein the plating layer comprises from more than 0.1 mass % to 5 mass % of Cr.

(3) The hot-dip Zn—Al alloy-plated steel material with excellent bending workability as described in (1) or (2), wherein the plating layer further comprises from 0.1 to 5 mass % of Mg.

(4) The hot-dip Zn—Al alloy-plated steel material with excellent bending workability as described in any one of (1) to (3), which has an alloyed layer containing one or both of Cr and Mn at the interface between the plating layer and the steel material.

(5) The hot-dip Zn—Al alloy-plated steel material with excellent bending workability as described in any one of (1) to (4), wherein the average spangle size on the plating surface is 1.0 mm or more.

(6) The hot-dip Zn—Al alloy-plated steel material with excellent bending workability as described in (5), wherein the average spangle size on the plating surface is 3.0 mm or more.

(7) A method for producing a hot-dip Zn—Al alloy-plated steel material with excellent bending workability, which is the hot-dip Zn—Al alloy-plated steel material described in any one of (1) to (6), the method comprising dipping and thereby hot-dip plating a steel material in a plating bath comprising, in terms of mass %, from 25 to 85% of Al, from 0.05 to 5% of one or both of Cr and Mn, and Si in an amount of 0.5 to 10% of the Al content, with the balance being Zn and unavoidable impurities, cooling the plated steel material at a cooling rate of 20° C./sec or less to a temperature of completing solidification of the plating layer, and thermally insulating the steel material after solidification under the condition specified by the following formula (I):

y≧7.5×10⁹×t^{-4.5} (1)

(wherein t represents a temperature for thermally insulating the plated steel material at 100 to 250° C., and y represents a thermal insulation time (hr)).

(8) The method for producing a hot-dip Zn—Al alloy-plated steel material with excellent bending workability as described in (7), wherein the plating bath further comprises from 0.1 to 5 mass % of Mg.

(9) The method for producing a hot-dip Zn—Al alloy plated steel material with excellent bending workability as described in (7) or (8), wherein the cooling rate of the plated steel material is 15° C./sec or less.

### BRIEF DESCRIPTION OF THE DRAWING

FIG. 1 shows the relationship between the thermal insulation condition after plating and the bending workability of the plating layer.

### BEST MODE FOR CARRYING OUT THE INVENTION

The present invention is described in detail below.

The hot-dip Zn—Al alloy-plated steel material with excellent corrosion resistance of the present invention is characterized in that the plating layer has a composition comprising from 25 to 75 mass % of Al, from 0.05 to 5 mass % of one or both of Cr and Mn, and Si in an amount of 0.5 to 10 mass % of the Al content, with the balance being Zn and unavoidable impurities. The plating layer composition preferably further comprises from 0.1 to 5 mass % of Mg. Here, the steel material to be plated is an iron or steel material such as steel sheet, steel pipe and steel wire.

Out of the plating layer composition, Al is from 25 to 75 mass %. If Al is less than 25 mass %, the corrosion resistance decreases, whereas if it exceeds 75 mass %, the corrosion resistance of the cut edge decreases or the alloy plating bath must be kept at a high temperature and this causes a problem such as high production cost. Also, out of the plating layer composition, one or both of Cr and Mn is from 0.05 to 5 mass %. If one or both of Cr and Mn is less than 0.05 mass %, the effect of enhancing the corrosion resistance is insufficient, whereas if it exceeds 5 mass %, there arises a problem such as increase in the amount of dross generated in the plating bath. In view of corrosion resistance, one or both of Cr and Mn is preferably contained in excess of 0.1 mass %. Cr is more preferably from more than 0.1 mass % to 5 mass %, still more preferably from 0.2 to 5 mass %.

Out of the plating layer composition, Si is added in an amount of 0.5% or more of the Al content, because it helps to prevent excessive growth of the Fe—Al alloy layer formed at steel/plating interface, and thus enhance the adhesion of the plating layer to the steel surface. If Si is contained in excess of 10% of the Al content, the effect of suppressing the formation of an Fe—Al alloyed layer is saturated and at the same time, this may incur reduction in the workability of the plating layer. Therefore, the upper limit is 10% of the Al content. When the workability of the plating layer is important, the upper limit is preferably 5% of the Al content.

As for the structure of the plating layer, the average spangle size is 0.5 mm or more. The spangle size is measured by observing the plating surface through an optical microscope. In the solidification structure, Al dendrite cells are observed, and the distance between centers of dendrite cells is measured through observation generally by an optical microscope at an about 20-fold to 50-fold magnification. If the average spangle size is less than 0.5 mm, when the plating layer is bend-worked, many cracks are generated and the bending workability decreases. Furthermore, the spangle pattern as a characteristic feature of the plated steel material of the present invention cannot be recognized with an eye and the outer appearance is impaired. In the case where bending workability in a higher level is required, the average spangle size is preferably 1.0 mm or more, more preferably 3.0 mm or more.

The upper limit of the spangle size is not particularly specified, but if the spangle size becomes coarse, the outer appearance is rather impaired and therefore, the preferred spangle size is usually 10 mm or less.

The reason why the spangle size affects the workability of the plating layer is not clearly known at present but is considered as follows: in the case where the cooling rate until the completion of solidification of the plating layer after hot-dip plating is high or where thermal insulation is not performed under the condition specified by formula (I) after solidification, the spangle size becomes fine and at the same time, the hardness of the plating layer is elevated, as a result, many cracks are generated in the plating layer upon receiving bending deformation.

When the plating layer composition further comprises from 0.1 to 5 mass % of Mg, higher corrosion resistance can be obtained. If Mg is added in an amount of less than 0.1 mass %, the addition cannot provide an effect contributing the enhancement of corrosion resistance, whereas if the amount added exceeds 5 mass %, the effect of enhancing the corrosion resistance is saturated and at the same time, there is a high possibility of causing a problem such as increase in the amount of dross generated in the plating bath.

In the structure of the plating layer, the Fe—Al alloyed layer formed at the interface between the plating layer and the base steel material preferably contains one or both of Cr and Mn. By virtue of the passivation of Cr and the sacrificial corrosion protection of Mn, the Cr and Mn condensed in the Fe—Al alloyed layer are considered to exert an effect of preventing corrosion of the base steel material and enhancing the corrosion resistance in the process of the plating layer being dissolved along the progress of corrosion and a part of the base steel material surface being exposed.

The alloyed layer containing Cr and Mn can be confirmed by the EPMA or GDS analysis of the cross section of the plating layer. The film thickness of the alloyed layer is not particularly limited but the effect by the formation of the alloyed layer is obtained when the thickness is 0.05 μm or more. If the thickness is too large, the bending workability of the plating layer decreases and this is not preferred. The thickness is preferably 3 μm or less. The formation of the alloyed layer starts immediately after the dipping of a steel material to be plated in a hot-dip plating bath and thereafter, proceeds until solidification of the plating layer is completed and the temperature of the plated steel material drops to about 400° C. or less. Accordingly, the thickness of the alloyed layer can be controlled by adjusting, for example, the temperature of plating bath, the dipping time of steel material to be plated, or the cooling rate after plating.

In order to obtain an average spangle size of 0.5 mm or more and ensure good bending workability of the plating layer, the steel material after solidification must be thermally insulated under the condition specified by the following formula (I):

y≧7.5×10⁹×t^{-4.5} (1)

(wherein t represents a temperature for thermally insulating the plated steel material at 100 to 250° C., and y represents a thermal insulation time (hr)).

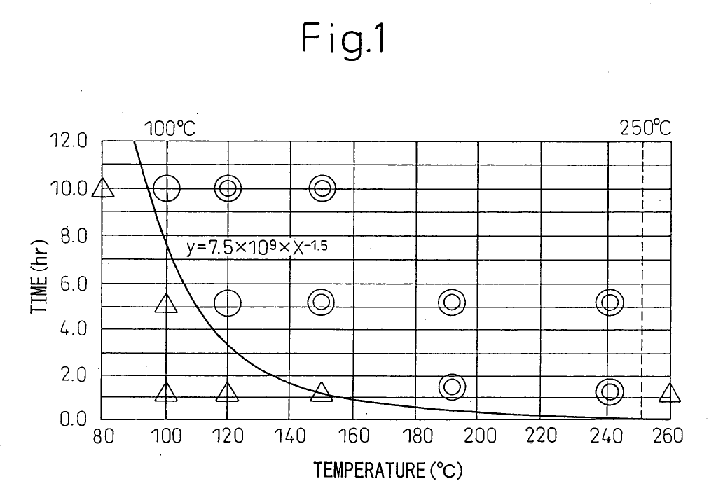

FIG. 1 shows the results when a plated material having a plating layer thickness of 15 μm, which was plated by employing a plating composition of 55% Al-1.5% Si-0.2% Cr-1% Mg-balance of Zn and cooled at a rate of 15° C./sec, was subjected to a heat/thermal insulation treatment and the relationship of the bending workability of the plating layer with the thermal insulation temperature and thermal insulation time was examined. Here, in the bending workability test of the plating layer, after 3T bend working, a 1 mm length portion of the bend-worked top part was observed by a microscope and rated according to the following criteria (3T bend working means bending a plate having a thickness T by which a dummy plate having a thickness of 3T is sandwiched at the bending portion; therefore bending is severer in the order of 0T, 1T, 2T, 3T):

⊚: no bending crack (a remarkable improvement effect as compared with the material not subjected to thermal insulation/heat treatment),

◯: from 1 to 5 bending cracks (there is an improvement effect as compared with the material not subjected to thermal insulation/heat treatment),

Δ: from 6 to 10 bending cracks (on the same level as the material not subjected to thermal insulation/heat treatment).

If the thermal insulation temperature is less than 100° C., a long thermal insulation time is necessary for obtaining the effect of improving the bending workability and this causes a problem of reduction in the productivity, whereas even if it exceeds 250° C., a higher improvement effect is not obtained.

The formula above is determined by exponentially approximating the relationship between thermal insulation temperature and thermal insulation time for the condition of giving the effect of improving the bending workability of the plating layer, which is obtained in the test and shown in FIG. 1. The reason why workability of the plating layer is more improved by the heat/thermal insulation treatment is presumed to rely on the following mechanism. When the plated material produced is in that state as-is, many fine precipitate particles are present in the plating layer. The fine precipitate particle inhibits the transfer of transition at the bending deformation of the plating layer and decreases the workability of the plating layer. By applying a heat/thermal insulation treatment, the fine precipitate particles are coarsened and the workability of the plating layer is improved. Incidentally, if a thermal insulation/heat treatment exceeding 250° C. is applied, the coarse precipitate particle itself is melted in the plating layer and when the plated material is cooled, fine precipitate particles are again produced, as a result, the effect of improving the workability of the plating layer is not obtained.

In the plating layer composition, the balance, that is, the components other than Al, Cr, Mn and Si, comprises zinc and unavoidable impurities. The unavoidable impurity as used herein means an element unavoidably mingled in the production process of a plating alloy raw material, such as Pb, Sb, Sn, Cd, Fe, Ni, Cu and Ti, and an element dissolved out from the steel material or plating pot material and mingled in the plating bath. These unavoidable impurities may be contained in a total content up to 1 mass %.

The plating thickness is not particularly limited, but if the plating thickness is too small, the effect of enhancing the corrosion resistance by the plating layer is insufficient, whereas if it is too large, the bending workability of the plating layer decreases and a problem such as generation of cracks is readily caused. Accordingly, the plating thickness is preferably from 5 to 40 μm. In the case where particularly good bending workability is required, the upper limit of the plating thickness is preferably 15 μm or less.

In the production method of a plated steel material of the present invention, a steel material to be plated is dipped in a plating bath comprising, in terms of mass %, from 25 to 85% of Al, from 0.05 to 5% of one or both of Cr and Mn, and Si in an amount of 0.5 to 10% of the Al content, and containing, if desired, from 0.1 to 5 mass % of Mg, with the balance being Zn and unavoidable impurities, and the plated steel material is cooled to a temperature of completing solidification of the plating layer at a cooling rate of 20° C./sec or less, preferably 15° C./sec or less, more preferably 10° C./sec or less. Before dipping in the plating bath, the steel material to be plated may be subjected to an alkali degreasing treatment and a pickling treatment for the purpose of improving the plating wettability, plating adhesion or the like.

As for the method of plating a steel material to be plated, a method of continuously performing steps of reduction-annealing a steel material to be plated under heating by using a non-oxidation furnace→reduction furnace system or an entire reduction furnace, dipping it in a plating bath, pulling up the plated steel material and after controlling a predetermined plating thickness by a gas-wiping system, cooling the steel material may be used. A plating method of applying a flux treatment to the surface of a steel material to be plated by using zinc chloride, ammonium chloride or other chemicals, and then dipping the steel material in a plating bath may also be used.

As for the preparation method of a plating bath, an alloy previously prepared to a composition within the range specified in the present invention may be heat-melted, or a method of heat-melting respective metal elementary substances or two or more alloys in combination to obtain a predetermined composition may also be used. The heat-melting may be performed by a method of directly melting the plating alloy in a plating bath or by a method of previously melting the plating alloy in a pre-melting furnace and transferring the melt to a plating bath. The method of using a pre-melting furnace is advantageous, for example, in that impurities such as dross generated at the melting of a plating alloy are easily removed or the temperature control of the plating bath is facilitated, though the cost for equipment installation is high.

The surface of the plating bath may be covered with a heat-resistant material such as ceramic, glass and wool so as to reduce the amount of oxide-type dross generated resulting from contact of the plating bath surface with air. The cooling rate until cooling and solidification of the hot-dip plating layer is set to 20° C./sec or less and the thermal insulation is performed under the condition of formula (I) after solidification, whereby the average spangle size becomes 0.5 mm or more and good workability is obtained. If the cooling rate exceeds the above-described range, the spangle size becomes fine and not only the bending workability of the plating layer deteriorates but also the surface appearance is impaired. If the thermal insulation under the condition of formula (I) is not carried out, spangles with the desired size is not obtained.

The cooling rate of the plated steel material after hot-dip plating is controlled in the interval between withdrawal of the plated steel material from the hot-dip plating bath and the completion of solidification of the plating layer. As for the specific method, the cooling rate can be controlled by adjusting the atmosphere temperature in the periphery of the plated steel material, by adjusting the relative velocity of wind blown to the plated steel material or, if desired, by using an induction heating or combustion-type heating burner. The cooling rate of the plated steel material can be calculated by measuring the time after the plated steel material is withdrawn from the hot-dip plating bath until the solidification of the hot-dip plating layer is completed. Here, the completion of solidification of the hot-dip plating layer can be confirmed by observing the change in the surface state with an eye. The time until solidification can be determined by dividing the distance to the completion of solidification of the plating layer by the production rate.

The cooling rate of the plated steel material after the completion of solidification of the plating layer is not particularly specified, but the plated steel material is preferably cooled at a rate of 30° C./sec or more, because the effect of improving the bending workability of the plating layer is more enhanced. However, in the present invention, the plated steel material after solidification must be further thermally insulated under the conditions as stated by the above formula (I) for the purpose of obtaining good bending workability of the plating layer.

As for the thermal insulation method, for example, a method of, at the continuous hot-dip plating production, taking up the plated steel material while keeping it at a temperature higher than the temperature condition specified in the present invention, and thermally insulating the plated steel material as-is may be used. In the case where the plated steel material after the continuous hot-dip plating production is cooled to a temperature lower than the temperature condition specified in the present invention, for example, a method of heating and thermally insulating the plated steel material by using a heating and thermally insulating box or the like, or a method of once unwinding the plated steel material, re-heating it to a predetermined temperature by using an induction heating device or a continuous heating furnace, and then taking up and thermally insulating the plated steel material may be applied.

The surface of the hot-dip Zn—Al alloy-plated steel material of the present invention may be subjected, for example, to coating with a coating material such as polyester resin type, acryl resin type, fluororesin type, vinyl chloride resin type, urethane resin type and epoxy resin type by roll coating, spray coating, curtain flow coating or dip coating, or to film lamination of laminating a plastic film such as acryl resin film. When a coating is formed on the plating layer in this way, excellent corrosion resistance can be exerted at the flat surface part, cut edge part and bend-worked part in a corrosive atmosphere.

### EXAMPLES

The present invention is described in greater detail below.

A steel material to be plated is dipped in a bath containing a hot-dip plating metal having a composition shown in Table 1 and then treated under the conditions (plating composition, cooling rate to a temperature of completing solidification of the plating layer, and temperature and time for thermal insulation after solidification) to produce an alloy-plated steel material. In Invention Example Nos. 1 to 19 and Comparative Example Nos. 20 to 22, a cold-rolled steel sheet having a thickness of 0.8 mm was alkali-degreased before plating, reduction-annealed under heating to 800° C. in an N₂-10% H₂ atmosphere and after cooling to 580° C., dipped in a hot-dip plating bath for 2 seconds to form an alloy plating layer on the surface. The plating film thickness was controlled to 10 to 15 μm. The temperature of the hot-dip plating bath was set to 560° C. in Invention Example No. 9, to 640° C. in Invention Example No. 10, and to 605° C. in others. Then the cooling and thermal insulation under the conditions as shown in Table 1 were carried out.

Then the plating layer was dissolved and the composition of each of the plating portion and the alloy layer at the interface with the plating base was examined by chemical analysis. The plating thickness was examined by comparing the weights before and after dissolving. Also, the surface was observed by an optical microscope to examine the spangle size (average). At the same time, the bend workability and corrosion resistance were evaluated by the following methods.

### (Bend Workability Test)

An alloy-plated steel material was cut into a size of 30 mm×40 mm and the bend working test of the plating layer was performed. In the bend workability test of the plating layer, 3T bend working was performed and then a 1 mm length portion of the bend worked top part was observed through a microscope and judged according to the following criteria. Ratings of A-C were judged as passed.

A: No bending crack.

B: From 1 to 5 bending cracks.

C: From 6 to 10 bending cracks.

D: Ten or more bending cracks.

### (Corrosion Resistance Test)

A salt water spraying test of the alloy-plated steel material was performed for 20 days. As for the method of measuring the plating corrosion weight loss, the material after the corrosion test was dipped in a treating bath containing 200 g/L of CrO₃ at a temperature of 80° C. for 3 minutes and the corrosion product was dissolved and removed. The plating corrosion weight loss associated with corrosion was measured in terms of the mass. The corrosion resistance was judged according to the following evaluation criteria and ratings of A and B were judged as passed.

A: Plating corrosion weight loss of 5 g/m² or less.

B: Plating corrosion weight loss of more than 5 g/m² to 10 g/m².

C: Plating corrosion weight loss of more than 10 g/m² to 20 g/m².

D: Plating corrosion weight loss of more than 20 g/m².

TABLE 1

| | | | | | | | | | Alloy Layer at | Cooling Rate | Thermal | | | Corro- | |
|---|---|---|---|---|---|---|---|---|---|---|---|---|---|---|---|
| | Plating Composition | | | | | | Si/Al | Spangle | Interface of | after Hot- | Insulation | | Bend | sion | |
| | (mass %) | | | | | | Ratio | Size | Plating/Base | Dip Plating | Temper- | | Work- | Resis- | |
| No. | Al | Cr | Mn | Si | Mg | Zn | (%) | (mm) | Steel Material | (° C./sec) | ature | Time | ability | tance | Remarks |
| 1 | 55 | 0.5 | — | 1.6 | 0 | bal | 2.91 | 0.5 | Fe, Al, Cr, Si | 19 | 120 | 4 | C-B | B | Invention |
| 2 | 55 | 0.5 | — | 1.6 | 0 | bal | 2.91 | 1.0 | Fe, Al, Cr, Si | 15 | 100 | 10 | B | B | Example |
| 3 | 55 | 0.5 | — | 1.6 | 0 | bal | 2.91 | 3.0 | Fe, Al, Cr, Si | 10 | 150 | 5 | A | B | |
| 4 | 55 | 0.1 | — | 1.6 | 0 | bal | 2.91 | 1.0 | Fe, Al, Cr, Si | 15 | 120 | 5 | B | B | |
| 5 | 55 | 0.5 | — | 1.6 | 0 | bal | 2.91 | 1.0 | Fe, Al, Cr, Si | 15 | 150 | 3 | B | B | |
| 6 | 55 | — | 1 | 1.6 | 0 | bal | 2.91 | 1.0 | Fe, Al, Mn, Si | 15 | 170 | 1.5 | B | B | |
| 7 | 55 | 0.5 | 2 | 1.6 | 0 | bal | 2.91 | 1.0 | Fe, Al, Cr, | 15 | 110 | 6 | B | B | |
| | | | | | | | | | Mn, Si | | | | | | |
| 8 | 30 | 0.5 | — | 0.3 | 0 | bal | 1.00 | 1.0 | Fe, Al, Cr, Si | 14 | 130 | 3.5 | B | B | |
| 9 | 80 | 0.5 | — | 2 | 0 | bal | 2.50 | 1.0 | Fe, Al, Cr, Si | 15 | 160 | 2 | B | A | |
| 10 | 55 | 0.5 | — | 1.6 | 0.1 | bal | 2.91 | 1.1 | Fe, Al, Cr, Si | 14 | 150 | 1.5 | B | B | |
| 11 | 55 | 0.5 | — | 1.6 | 1 | bal | 2.91 | 0.5 | Fe, Al, Cr, Si | 19 | 100 | 8 | C | A | |
| 12 | 55 | 0.5 | — | 1.6 | 1 | bal | 2.91 | 1.0 | Fe, Al, Cr, Si | 14 | 160 | 1 | C-B | A | |
| 13 | 55 | 0.5 | — | 1.6 | 1 | bal | 2.91 | 3.0 | Fe, Al, Cr, Si | 9 | 150 | 10 | B | A | |
| 14 | 55 | 0.5 | — | 1.6 | 4 | bal | 2.91 | 1.0 | Fe, Al, Cr, Si | 13 | 260 | 1 | C | A | |
| 15 | 55 | 0.5 | — | 1.6 | 0 | bal | 2.91 | 1.0 | Fe, Al, Cr, Si | 15 | 240 | 1 | A | B | |
| 16 | 55 | 0.5 | — | 1.6 | 0 | bal | 2.91 | 3.0 | Fe, Al, Cr, Si | 15 | 240 | 5 | A | B | |
| 17 | 55 | 0.5 | — | 1.6 | 0 | bal | 2.91 | 1.0 | Fe, Al, Cr, Si | 15 | 190 | 1.5 | A | B | |
| 18 | 55 | 0.5 | — | 1.6 | 0 | bal | 2.91 | 1.0 | Fe, Al, Cr, Si | 15 | 190 | 5 | A | B | |
| 19 | 55 | — | 1 | 1.6 | 0 | bal | 2.91 | 1.5 | Fe, Al, Mn, Si | 15 | 150 | 10 | A | B | |
| 20 | 55 | 0.5 | — | 1.6 | 0 | bal | 2.91 | 0.3 | Fe, Al, Cr, Si | 30 | — | — | D | B | Compar- |
| 21 | 55 | 0.5 | — | 1.6 | 1 | bal | 2.91 | 0.2 | Fe, Al, Cr, Si | 30 | — | — | D | B | ative |
| 22 | 55 | — | — | 1.6 | 0 | bal | 2.91 | 0.2 | Fe, Al, Si | 30 | — | — | D | C | Example |

As apparent from Table 1, in all of Invention Example Nos. 1 to 19, the bending workability and the corrosion resistance are good. On the other hand, in Comparative Example Nos. 20 to 22, since the cooling rate after plating is high and the spangle size is small, the bend workability is not good. In Comparative Example No. 22, since Cr and Mn are not contained in the plating layer, the corrosion resistance is insufficient.

### INDUSTRIAL APPLICABILITY

The hot-dip Zn—Al alloy-plated steel material of the present invention has good bending workability of the plating layer and can be suitably used in the field of usage for building materials, automobiles and home appliances, where bending work of a steel material is often required, and the industrial utility value thereof is very high. Furthermore, in the production method of a plated steel material of the present invention, the existing hot-dip plating equipment can be used as-is and a plated steel material can be easily and efficiently produced without causing great increase of the production cost.

1. A hot-dip Zn—Al alloy-plated steel material with excellent bending workability, having a plating layer comprising, in terms of mass %,
Al: from 25 to 85%,
one or both of Cr and Mn: from 0.05 to 5%, and
Si: from 0.5 to 10% of the Al content,
with the balance being Zn and unavoidable impurities, wherein the average spangle size on the plating surface is 0.5 mm or more.

2. The hot-dip Zn—Al alloy-plated steel material with excellent bending workability as claimed in claim 1, wherein said plating layer comprises from more than 0.1 mass % to 5 mass % of Cr.

3. The hot-dip Zn—Al alloy-plated steel material with excellent bending workability as claimed in claim 1, wherein said plating layer further comprises from 0.1 to 5 mass % of Mg.

4. The hot-dip Zn—Al alloy-plated steel material with excellent bending workability as claimed in claim 1, which has an alloyed layer containing one or both of Cr and Mn at the interface between said plating layer and the steel material.

5. The hot-dip Zn—Al alloy-plated steel material with excellent bending workability as described in claim 1, wherein the average spangle size on the plating surface is 1.0 mm or more.

6. The hot-dip Zn—Al alloy-plated steel material with excellent bending workability as described in claim 5, wherein the average spangle size on the plating surface is 3.0 mm or more.

7. A method for producing a hot-dip Zn—Al alloy-plated steel material which is the hot-dip Zn—Al alloy-plated steel material as claimed in claim 1, said method comprising dipping and thereby hot-dip plating a steel material in a plating bath comprising, in terms of mass %, from 25 to 85% of Al, from 0.05 to 5% of one or both of Cr and Mn, and Si in an amount of 0.5 to 10% of the Al content, with the balance being Zn and unavoidable impurities, cooling the plated steel material at a cooling rate of 20° C./sec or less to a temperature of completing solidification of the plating layer, and thermally insulating the steel material after solidification under the condition specified by the following formula (I):
y≧7.5×10⁹×t^{-4.5} (1)
(wherein t represents a temperature for thermally insulating the plated steel material at 100 to 250° C., and y represents a thermal insulation time (hr)).

8. The method producing a hot-dip Zn—Al alloy-plated steel material as claimed in claim 7, wherein said plating bath further comprises from 0.1 to 5 mass % of Mg.

9. The method for producing a hot-dip Zn—Al alloy plated steel material with excellent bending workability as described in claim 7, wherein the cooling rate of the plated steel material is 15° C./sec or less.
